(19) United States
(12) Patent Application Publication
(10) Pub. No.: US 2009/0091641 A1
(43) Pub. Date: Apr. 9, 2009

(54) Solid-state image capturing apparatus and electronic information device

(75) Inventor: Shinji Hattori, Higashiosaka-shi (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/152,715

(22) Filed: May 16, 2008

(30) Foreign Application Priority Data
May 16, 2007 (JP) 2007-131072

(51) Int. Cl. H04N 5/217

(52) U.S. Cl. 348/241; 348/E05.078

(57) ABSTRACT

A solid-state image capturing apparatus is provided, the apparatus including: a pixel section having a plurality of pixels arranged in a matrix therein; an A/D conversion circuit for performing A/D conversion of pixel signals that are read out from pixels of the pixel section to output digital pixel values; and a correcting logic circuit for receiving the digital pixel values outputted from the A/D conversion circuit and correcting the digital pixel value of effective pixels on each of horizontal pixel lines based on an average horizontal optical black value, which is an average digital pixel value of a plurality of shaded pixels in a corresponding horizontal pixel line.

This Nonprovisional application claims priority under 35 U.S.C. §119(a) on Patent Application No. 2007-131072 filed in Japan on May 16, 2007, the entire contents of which are hereby incorporated by reference.

### BACKGROUND OF THE INVENTION

1. Field of the Invention

The present invention relates to a solid-state image capturing apparatus and an electronic information device, and more particularly to a correction of a transverse line in the solid-state image capturing apparatus and in the electronic information device using the solid-state image capturing apparatus.

2. Description of the Related Art

In recent years, electronic image capturing apparatuses, such as a video camera and a digital camera, have become widely used. Such electronic image capturing apparatuses take an image of a subject and record the digital image data on a recording medium, and a CMOS image sensor, a CCD image sensor and the like are used as a solid-state image capturing apparatus attached thereto.

Image sensors have the problem of having transverse line noise because signal levels change in every transverse line due to the fluctuation of the power supply voltage. On account of this, there are conventionally image sensors which correct the transverse lines using the optical black value from the shaded pixels.

For example, Reference 1 discloses a conventional image sensor, which performs a noise reduction using a median treatment and the like when correcting transverse lines using the optical black values from the shaded pixels. FIG. 7 shows an exemplary structure of such a conventional image sensor.

An image sensor 20 shown in FIG. 7 includes: a pixel section 200a having a plurality of pixels arranged in a matrix therein, and an A/D conversion circuit 202 for performing A/D conversion of pixel data (pixel signals) that are read out from the pixels to output digital pixel data (digital pixel values) Dad. Herein, the pixel section 200a includes an optical black section 201 (which is called a horizontal OB pixel section hereinafter), which corresponds to sixty-four pixels that are shaded on the left side of the page, and an effective pixel section 200, which is not shaded and in which photoelectric conversion is performed for each pixel in response to light coming in from the outside.

The image sensor 20 further includes a longitudinal line correcting logic circuit 203 for correcting the digital pixel value Dad outputted from the A/D conversion circuit 202 so as to suppress longitudinal line noise to output a longitudinal line corrected pixel value Dua, and a transverse line correcting logic circuit 210 for correcting the longitudinal line corrected pixel value Dua outputted from the longitudinal line correcting logic circuit 203 so as to suppress transverse line noise to output a corrected pixel value Dao as a corrected output value.

The transverse line correcting logic circuit 210 includes: a horizontal OB median circuit 205 for calculating corrected horizontal OB values Dha from the horizontal OB values of forty-eight pixels in the digital pixel values (also called horizontal OB values hereinafter) of sixty-four pixels for one line in the horizontal OB pixel section 201, and an addition circuit 206 for outputting a corrected pixel value Dao, in which corrections for the longitudinal line and the transverse line are made, by adding a corrected horizontal OB value Dha from the horizontal OB median circuit 205 to the longitudinal line corrected pixel value Dua of effective pixels, from the longitudinal line correcting logic circuit 203 described above.

Herein, the horizontal OB median circuit 205 extracts the center value of the horizontal OB value of forty-eight pixels or the average value of the center value and the neighboring pixel value as the horizontal OB median value, and the horizontal OB median circuit 205 subtracts the extracted horizontal OB median value from a predetermined optical black value to output the value obtained by the subtraction as the corrected horizontal OB value Dha. In addition, the predetermined optical black value includes, for example, 64 LSB, which means a pixel value level that can be expressed with 10 Bits and which is in a 64th pixel value level beginning from the lowest bit LSB between 0 to 1023 LSB.

Next, the operation will be described.

The pixel data (pixel signal) from the pixel section 200a is converted to, for example, a 10 bit digital pixel value in the A/D conversion circuit 202, and the digital pixel value is input in the longitudinal line correcting logic circuit 203. The longitudinal line correcting logic circuit 203 extracts a longitudinal correction level based on a horizontal OB value or the digital pixel value of the pixels (horizontal OB pixels) in the horizontal OB pixel section 201 and corrects the digital pixel value of the pixels (called effective pixels hereinafter) in the effective pixel section based on the longitudinal correction level to output the longitudinal line corrected pixel value Dua.

After the longitudinal line corrected pixel value Dua from the longitudinal line correcting logic circuit 203 is input in the transverse line correcting logic circuit 210, the transverse line correcting logic circuit 210 extracts the corrected horizontal OB value Dha based on digital pixel values of the horizontal OB pixels and corrects the digital pixel values of the effective pixels by the corrected horizontal OB value Dha, so that the digital pixel value corrected for a transverse line is output as a corrected output value Dao.

Specifically, when the digital pixel values of the horizontal OB pixels that correspond to one line in the horizontal OB pixel section 201, or sixty-four horizontal OB values, are input in the transverse line correcting logic circuit 210, these values are provided for the horizontal OB median circuit 205 in the transverse line correcting logic circuit 210. Subsequently, the horizontal OB median circuit 205 extracts the intermediate value or the average value of the intermediate value and the neighboring value as the horizontal OB median value from the horizontal OB value of the forty-eight pixels among the sixty-four pixels in one pixel line of the horizontal OB pixel section.

For example, if the horizontal OB median value is assumed to be 32 LSB, the horizontal OB median circuit 205 performs an arithmetic processing to subtract the OB median value (32 LSB) from 64 LSB, 64 LSB being a set optical black value, so that the corrected horizontal OB value is calculated and is output to the adding circuit 206.

Then, subsequent to the input of the horizontal OB value for one pixel line followed by the effective pixel value of the corresponding pixel line in the transverse line correcting logic circuit 210, the effective pixel value is input in the adding circuit 206 without passing through the horizontal OB median circuit 205. In the adding circuit 206, the horizontal OB value Dha is added to the effective pixel value 200, so that the effective pixel value corrected for a transverse line is output as a corrected output value Dao.

Reference 1: Japanese Laid-Open Publication No. 2006-157263

### SUMMARY OF THE INVENTION

The horizontal OB median circuit 205 in the transverse line correcting logic circuit 210 of conventional image sensor, however, has a problem in that it requires a complicated arithmetic processing since the median value is extracted from the pixel value of forty-eight pixels among the sixty-four pixels that correspond to one line of the horizontal OB pixels.

More specifically, a comparison regarding large and small values is performed for the digital pixel values of forty-eight pixels, and therefore the digital pixel values for each pixel is input in an EXOR circuit bit by bit.

In addition, the arithmetic processing needs to be performed for a large number of times since it is necessary to compare the digital pixel values for all the forty-eight pixels.

Moreover, because the forty-eight pixels are ranked in size, when one pixel value is defined as 10 bit, resistors of as many as 48×10 bit are needed causing the size of the circuit to increase.

Furthermore, it is necessary to select the center value out of the data with the forty-eight pixels arranged by the magnitude order in order to extract the median value, and therefore it is necessary to provide an arithmetic circuit for selecting the center value.

Thus, the execution of finding the median value from the pixel values of forty-eight pixels is more complicated and requires a larger-scale arithmetic processing compared with extracting the average value from the pixel values of forty-eight pixels. Therefore, a problem arises that a complicated data processing is required for correcting a transverse line.

The present invention is intended to solve the conventional problems described above. The objective of the present invention is to provide a solid-state image capturing apparatus that is capable of performing a correction of a transverse line using a significantly simple logic circuit; and an electronic information device using the solid-state image capturing apparatus.

A solid-state image capturing apparatus according to the present invention includes: a pixel section having a plurality of pixels arranged in a matrix therein; an A/D conversion circuit for performing A/D conversion of pixel signals that are read out from pixels of the pixel section to output digital pixel values, and a correcting logic circuit for receiving the digital pixel values outputted from the A/D conversion circuit and correcting the digital pixel value of effective pixels on each of horizontal pixel lines based on an average horizontal optical black value, which is an average digital pixel value of a plurality of shaded pixels in a corresponding horizontal pixel line, in which the correcting logic circuit clamps the digital pixel values of a plurality of shaded pixels on each of the horizontal pixel lines within a certain definite range and find the average of the clamped digital pixel values of the plurality of shaded pixels within a certain definite range so as to calculate the average horizontal optical black value, thereby achieving the objective described above.

Preferably, in a solid-state image capturing apparatus according to the present invention, the correcting logic circuit corrects a prediction optical black value for the next horizontal pixel line, the prediction optical black value being a center value for the certain definite range, so that the average horizontal optical black value for each of the horizontal pixel lines converges at a constant value.

Preferably, in a solid-state image capturing apparatus according to the present invention, pixel signals of the shaded pixels are read out from the pixel section prior to pixel signals of the effective pixels, so that the digital pixel values of the shaded pixels on each of the horizontal pixel lines are input from the A/D conversion section to the correcting logic circuit prior to the digital pixel values of the effective pixels on the corresponding horizontal pixel lines.

Preferably, in a solid-state image capturing apparatus according to the present invention, the pixel section includes a shaded region arranged only on one side in a horizontal pixel line direction.

Preferably, in a solid-state image capturing apparatus according to the present invention, the average horizontal optical black value is generated from digital pixel values of part of shaded pixels arranged in the shaded region.

Preferably, in a solid-state image capturing apparatus according to the present invention, the shaded pixels used for the generation of the average horizontal optical black value is located in the center portion of a horizontal pixel line direction in the shaded region.

Preferably, in a solid-state image capturing apparatus according to the present invention, the pixel section is configured with a first shaded region arranged on one end side in a horizontal pixel line direction and a second shaded region arranged on the other end side in a horizontal pixel line direction.

Preferably, in a solid-state image capturing apparatus according to the present invention, the average horizontal optical black value is generated from the digital pixel values of part of shaded pixels arranged in the first shaded region and the digital pixel values of part of shaded pixels arranged in the second shaded region.

Preferably, in a solid-state image capturing apparatus according to the present invention, the shaded pixels used to generate the average horizontal optical is black value are located in the center portion in a horizontal pixel line direction in the first and second shaded regions.

Preferably, in a solid-state image capturing apparatus according to the present invention, the correcting logic circuit includes an effective pixel correction circuit for correcting digital pixel values of the effective pixels by adding a digital pixel value that corresponds to a difference between a set optical black value, which is set for the pixel section, and the average horizontal optical black value to the digital pixel values of the effective pixels.

Preferably, in a solid-state image capturing apparatus according to the present invention, the correcting logic circuit includes an upper limit limiting circuit for limiting an upper limit value of digital pixel values of shaded pixels used to generate the average horizontal optical black value; and a lower limit limiting circuit for limiting a lower limit value of digital pixel values of shaded pixels used to generate the average horizontal optical black value.

Preferably, in a solid-state image capturing apparatus according to the present invention, the correcting logic circuit includes an average circuit for averaging a plurality of digital pixel values that are clamped within a certain definite range to generate the average horizontal optical black value for every horizontal pixel line.

Preferably, in a solid-state image capturing apparatus according to the present invention, the correcting logic circuit includes a prediction arithmetic logic circuit for calculating a predictive optical black value, which is used for a reference value to set the upper limit value of the upper limit limiting circuit and the lower limit value of the lower limit limiting circuit for the next horizontal pixel line, based on the average horizontal optical black value for each of the horizontal pixel lines so as to output the predictive optical black value to the upper limit limiting circuit and the lower limit limiting circuit.

Preferably, in a solid-state image capturing apparatus according to the present invention, the prediction arithmetic logic circuit includes: a first arithmetic circuit for multiplying the average horizontal optical black value by 1/n (n is a positive integer);

a second arithmetic circuit for multiplying the predictive optical black value by (n−1)/n; an adding circuit for adding the outputs of the first and second arithmetic circuits; and a latch circuit for latching an added output from the adding circuit to output the added output to the second arithmetic circuit as the predictive optical black value, in which the predictive optical black value is updated for each of the horizontal pixel lines.

Preferably, in a solid-state image capturing apparatus according to the present invention, the upper limit limiting circuit sets a pixel value that is higher than the predictive optical black value by a certain level as the upper limit value; and the lower limit limiting circuit sets a pixel value that is lower than the predictive optical black value by a certain level as the lower limit value.

Preferably, in a solid-state image capturing apparatus according to the present invention, the correcting logic circuit limits the upper limit by the upper limit limiting circuit for the digital pixel values of the shaded pixels used for generating the average horizontal optical black value, and limits the lower limit by the lower limit limiting circuit for the digital pixel values of the shaded pixels used for generating the average horizontal optical black value, so that the correcting logic circuit clamps digital pixel values of a plurality of shaded pixels, which is used for generating the average horizontal optical black value, within a certain definite range with the predictive optical black value as a center.

Preferably, in a solid-state image capturing apparatus according to the present invention, the solid-state image capturing apparatus is a CMOS image sensor.

Preferably, in a solid-state image capturing apparatus according to the present invention, the solid-state image capturing apparatus is a CCD image sensor.

Preferably, an electronic information device uses the solid-state image capturing apparatus according to the present invention as an image capturing section, thereby achieving the objective described above.

The functions of the present invention having the structures described above will be described hereinafter.

According to the present invention, a correction logic circuit is provided for correcting digital values of effective pixels on each of horizontal pixel lines based on an average horizontal optical black value, which is an average of the digital pixel values of a plurality of shaded pixels on a horizontal pixel line. The correcting logic circuit clamps the digital pixel values of a plurality of shaded pixels in each of the horizontal pixel lines within a certain definite range and find the average of the clamped digital pixel values of the plurality of shaded pixels within a certain definite range so as to calculate the average horizontal optical black value. Therefore, the correcting logic circuit allows removing of noise such as white spot defect and correcting transverse lines by a simple process which clamps the digital pixel values of a plurality of shaded pixels within a certain definite range to find the average of the clamped digital pixel values of the plurality of shaded pixels within a certain definite range.

According to the present invention with the description above, a plurality of optical black values, which are pixel values of a plurality of shaded pixels in a horizontal pixel line, are clamped within a certain definite range, and the digital pixel values of the effective pixels in a corresponding horizontal pixel line are corrected based on the average horizontal optical black value that is obtained by finding the average of the plurality of clamped optical black values. Therefore, a simple arithmetic processing of clamping and finding the average of the plurality of the optical black values allows removing of noise such as white spot defect and correcting transverse lines. As a result, a solid-state image capturing apparatus that corrects transverse lines with a significantly simple logic circuit can be obtained.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram describing a solid-state image capturing apparatus according to Embodiment 1 of the present invention.

FIG. 2 shows a circuit block in the solid-state image capturing apparatus according to Embodiment 1, the circuit generating an average value of horizontal optical black pixels.

FIG. 3 shows a circuit block in the solid-state image capturing apparatus according to Embodiment 1, the block correcting pixel values of effective pixels.

FIG. 4 is a block diagram showing a detailed structure of a prediction arithmetic logic circuit that configures the solid-state image capturing apparatus according to Embodiment 1.

FIG. 5 is a diagram showing an operational timing of a prediction arithmetic logic circuit in the solid-state image capturing apparatus according to Embodiment 1, showing the relationship between the output timings for prediction OB values generated by the prediction arithmetic logic circuit and corrected horizontal OB values, and timings of frame intervals and line intervals.

FIG. 6 is a diagram showing a solid-state image capturing apparatus according to Embodiment 2 of the present invention.

FIG. 7 is a diagram showing a conventional solid-state image capturing apparatus.

FIG. 8 is a block diagram showing an exemplary schematic structure of an electronic information device using a solid-state image capturing apparatus according to Embodiments 1 or 2 of the present invention for an image capturing section thereof.

10, 10a solid-state image capturing apparatus
100 effective pixel section
100a pixel section
101 left horizontal OB pixel section
102 right horizontal OB pixel section
103 A/D conversion circuit
104 transverse line correcting logic circuit
105 upper limit limiting circuit
106 lower limit limiting circuit
107 average circuit
108 prediction arithmetic logic circuit
109 effective pixel correction circuit
110 ⅛ circuit
111 ⅞ circuit
112 adding circuit
113 latch circuit
Dad A/D conversion value
Dao corrected output value
Dav average OB value
Dud corrected horizontal OB value
Dpr predictive optical black value
Dur upper limit limited output
Dsr lower limit limited output
E enable signal
R reset signal

### DESCRIPTION OF THE PREFERRED EMBODIMENTS

Hereinafter, the embodiments of the present invention will be explained.

### Embodiment 1

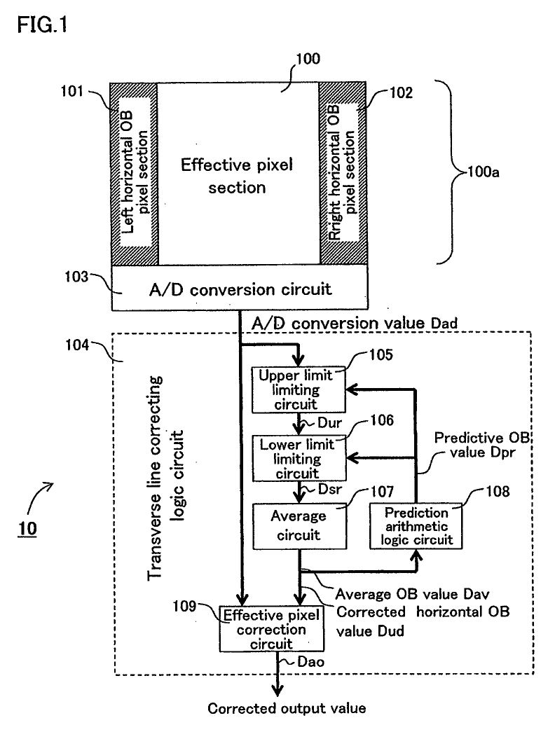

FIG. 1 is a block diagram describing a solid-state image capturing apparatus according to Embodiment 1 of the present invention and the figure shows a circuit structure of the solid-state image capturing apparatus.

A solid-state image capturing apparatus 10 according to Embodiment 1 includes: a pixel section 100a having a plurality of pixels arranged in a matrix therein, and an A/D conversion circuit 103 for performing A/D conversion of pixel data (pixel signals) that are read out from the pixels to output digital pixel data (hereinafter, digital pixel values) Dad as A/D conversion values. In Embodiment 1, the pixel section 100a includes an optical black section 101 (a left horizontal OB pixel section), in which sixty-four pixels (horizontal OB pixels) are arranged in a horizontal direction that are shaded on the left side of the page, an optical black section 102 (a right horizontal OB pixel section), in which sixty-four pixels (horizontal OB pixels) are arranged in a horizontal direction that are shaded on the right side of the page, and an effective pixel section 100, which is not shaded and in which photoelectric conversion is performed in each pixel (effective pixel) in respect to light coming in from the outside.

In addition, the solid-state image capturing apparatus 10 further includes a transverse line correcting logic circuit 104 for correcting the digital pixel values Dad outputted from the A/D conversion circuit 103 so as to suppress transverse line noise to output a transverse line corrected pixel values Dao as a corrected output values.

The transverse line correcting logic circuit 104 compares optical black values (also called OB pixel values hereinafter), which are digital values of horizontal OB pixels output from the A/D conversion circuit 103, with an upper limit value, which is determined based on a predictive optical black value that is a predictive value for the optical black value defined at the output of the correcting logic circuit. Subsequently, the transverse line correcting logic circuit 104 outputs the OB pixel value without change, which is smaller than the upper limit value. The transverse line correcting logic circuit 104 further includes an upper limit limiting circuit 105 for outputting the upper limit value as the OB pixel value for the OB pixel value which is larger than the upper limit value; and a lower limit limiting circuit 106 for comparing an OB pixel value Dur outputted from the upper limit limiting circuit 105 with a preset lower value and then outputting the OB pixel value without change when the OB pixel value is larger than the lower value or outputting the lower value as the OB pixel value when the OB pixel value is smaller than the lower value.

Herein, the upper limit limiting circuit 105 sets the upper value described above to a certain level higher than the predictive optical black value, which is, for example, a level that is higher by 32 LSB level, whereas the lower limit limiting circuit 106 sets the lower value described above to a certain level lower than the predictive optical black value, which is, for example, a level that is lower by 32 LSB level.

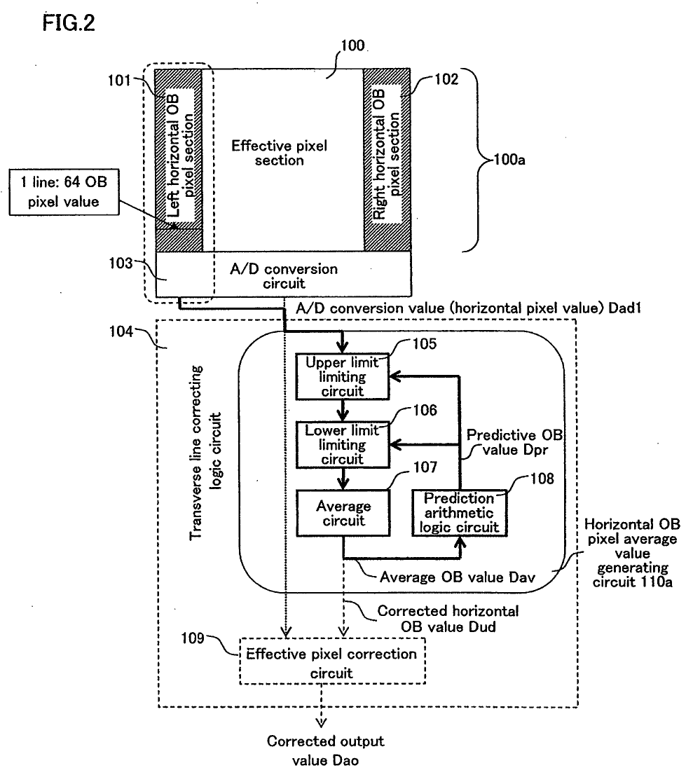

In addition, the transverse line correcting logic circuit 104 further includes an average value generation circuit 107 for generating an average value (average OB value) Dav by receiving an OB pixel value Dor for one line that is output from the lower limit limiting circuit 106; and a prediction arithmetic logic circuit 108 for generating the predictive optical black value Dpr described above based on the average optical black value Dav from the average value generation circuit 107 to output the predictive optical black value Dpr to the upper limit limiting circuit 105 and the lower limit limiting circuit 106. Herein, as shown in FIG. 2, the upper limit limiting circuit 105, the lower limit limiting circuit 106, the average value generation circuit 107 and the prediction arithmetic logic circuit 108 constitute a horizontal OB pixel average value generating circuit 110a for generating a corrected horizontal OB value Dud, which is a corrected value of the average value Dav of the OB pixel values for the left horizontal OB pixel section 101.

In addition, the transverse line correcting logic circuit 104 includes an effective pixel correction circuit 109 for correcting digital pixel values Dad of the effective pixels based on the corrected horizontal OB value Dud generated from the horizontal OB pixel average value generating circuit 110a to output digital pixel values corrected for transverse line as a corrected output values Dao.

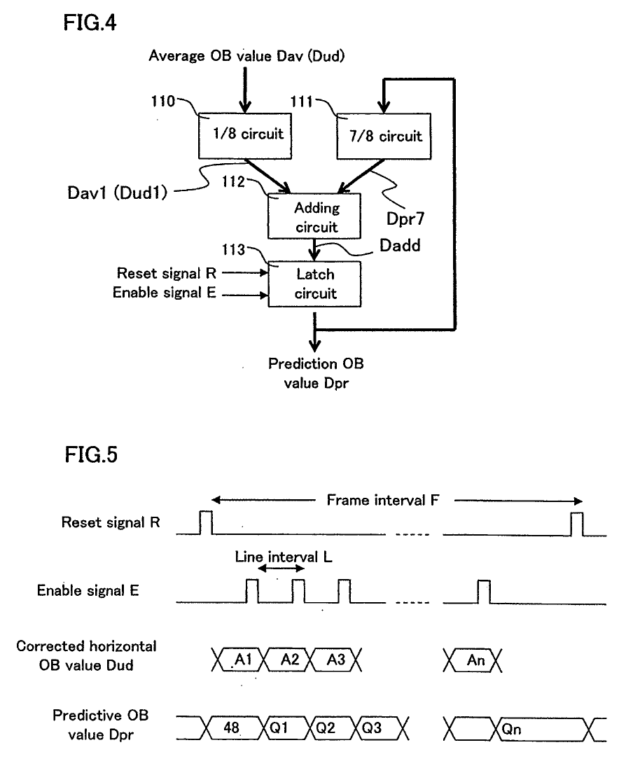

FIG. 4 is a block diagram showing a detailed structure of the prediction arithmetic logic circuit 108 described above.

The prediction arithmetic logic circuit 108 is a circuit for outputting the predictive optical black value Dpr based on the average OB value Dav, which is an output of the average value generation circuit 107 described above. The prediction arithmetic logic circuit 108 includes a ⅛ circuit 110 for multiplying the average OB value by ⅛ by shifting the average OB value, which is the average value of the OB pixel values, by 3 bits; and a ⅞ circuit 111 for generating a value in which the predictive optical black value Dpr is reduced to ⅞ by validating the top three bits of the predictive optical black value described above and defining the rest of the lower ranked bits as 0.

In addition, the prediction arithmetic logic circuit 108 includes an adding circuit 112 for adding a ⅛ average OB value Dav1, which is an output from the ⅛ circuit 110, and a ⅞ prediction OB value Dpr7, which is an output of the ⅞ circuit 111; and a latch circuit 113 for latching an output Dadd from the adding circuit 112 based on a reset signal R and an enable signal E. In addition, the adding circuit 112 holds an initial value with which the latch circuit 113 latches, which is 48 LSB level herein. The reset signal R becomes H level in synchronism with frame intervals and then becomes L level after a minute has passed whereas the enable signal E becomes H level in synchronism with line intervals and then becomes L level after one minute has passed.

The latch circuit 113 latches the initial value which the adding circuit holds at the rising timing of the reset signal R to the H level, and the latch circuit 113 also latches a updated prediction OB value Dpr, which is an output Dadd from the adding circuit 112, at the rising time of the enable signal E to the H level.

The operation will be explained next.

It is defined that the solid-state image capturing apparatus 10 according to Embodiment 1 performs the reading out of pixel data from the pixel section 100a starting from the top pixel line in the pixel section as well as the far left pixel in each pixel line and performs a calculation for a prediction OB value using the digital pixel value of the left horizontal OB pixel section only between the upper most pixel line and the eighth pixel line. However, the beginning of the read out for the pixel data from the pixel section 100a does not necessarily start from the top pixel line in the pixel section, but it may start from the lower most pixel line in the pixel section. In addition, the calculation for the prediction OB value is not limited between the top pixel line and the eighth pixel line, but it may be set as appropriate in accordance with the characteristic of the solid-state image capturing apparatus.

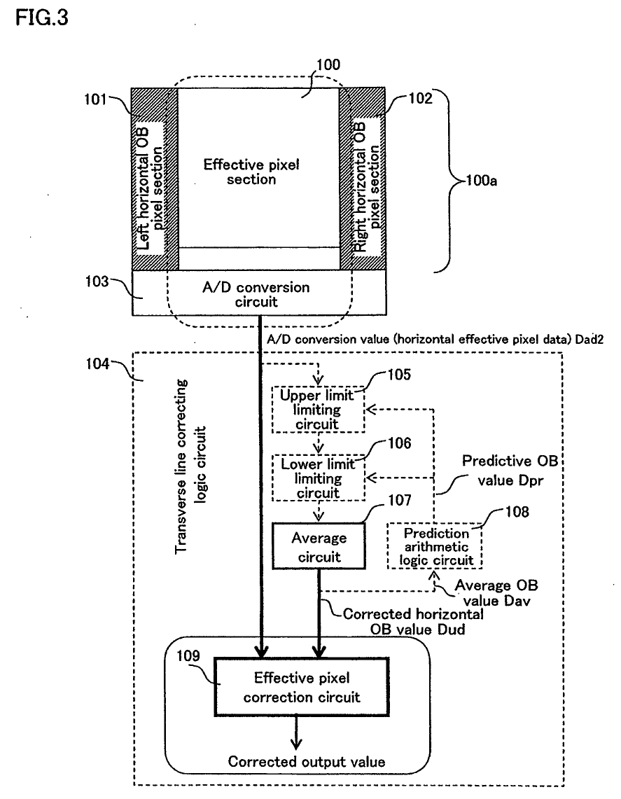

The operation of the solid-state image capturing apparatus 10 according to Embodiment 1 is divided into an operation of a circuit block for generating the average value of the horizontal OB pixels based on the digital values of the OB pixels in one horizontal pixel line as shown in FIG. 2; and an operation of a circuit block for correcting the digital pixel values of the effective pixels in one horizontal pixel line as shown in FIG. 3. Hereinafter, the operation of the respective blocks will be specifically explained for every pixel line.

(1) readout for a pixel value in the first pixel line:

When the readout for pixel data that corresponds to one frame starts, pixel data (pixel signals) in the first horizontal pixel line is read out by the A/D conversion circuit 103 and an A/D conversion is performed on the pixel data, and the A/D converted digital pixel data is output to the transverse line correcting logic circuit 104 as a digital pixel value (A/D conversion value) Dad.

In the transverse line correcting logic circuit 104, sixty-four OB pixel data of one pixel horizontal line is converted for every pixel to digital pixel data, such as 10 bit digital pixel values Dad1, by the A/D conversion circuit 103.

Subsequently, the digital pixel values (horizontal OB pixel values) Dad1 of the OB pixels in the left horizontal OB pixel section 101 are input to the horizontal OB pixel average value generating circuit 110a.

At this time, the latch circuit 113 in the prediction arithmetic logic circuit 108 latches the initial value (48 LSB level) from the adding circuit 112 by the reset signal R, and 48 LSB level is output as a prediction OB value Dpr to the upper limit limiting circuit 105 and the lower limit limiting circuit 106.

Therefore, the horizontal OB pixel values Dad1 from the A/D conversion circuit 103 are compared with the upper limit value, or 80 LSB level in which a constant level width of 32 LSB level is added to 48 LSB level, in the upper limit limiting circuit 105 described above. Subsequent to the comparison, the horizontal OB pixel value of the input data is output without change as an upper limit limiting OB pixel value Dur to the lower limit limiting circuit 106 if the horizontal OB pixel value of the input data is smaller than the upper limit value, whereas the upper limit is output as the upper limit limiting OB pixel value Dur if the horizontal OB pixel value of the input data is larger than the upper limit value.

Further, the output Dur from the upper limit limiting circuit 105 is compared with the lower limit value, or 16 LSB level in which 48 LSB level subtracted by a constant level width of 32 LSB level in the lower limit limiting circuit 106. As a result of the comparison, the lower limit value is output as a lower limit limiting OB pixel value Dsr from the lower limit limiting circuit 106 if the input data (upper limit limiting OB pixel value) Dur is smaller than the lower limit value, whereas the input value from the upper limit limiting circuit 105 is output without change as a lower limit limiting OB pixel value Dsr to the average circuit 107 if the input data (upper limit limiting OB pixel value) Dur is larger than the lower limit value.

As described above, when each horizontal OB pixel value that is clamped by the upper limit limiting value and the lower limit limiting value described above is input into the average circuit 107, the OB pixel value for one line in the left horizontal OB pixel section 101, or the average Value (A1) of the pixel values of 48 OB pixels among 64 OB pixels, is generated and is output as an average OB value Dav to the effective pixel correction circuit 109 and the prediction arithmetic logic circuit 108.

Further, in the effective pixel correction circuit 109, digital pixel values Dad2 of pixels in the effective pixel section 100, following the digital pixel value of the horizontal OB pixels in the left horizontal OB pixel section 101, are corrected based on the average OB value Dav from the average circuit 107.

More specifically, 48 LSB level is set between 0-1024 LSB as an optical black value, and it is assumed that the pixel data of the effective pixel section is A/D converted at the level lower by 32 LSB level that is obtained by subtracting the average OB value (16 LSB level) from a set value (48 LSB level) of the optical black value if the average OB value Dav obtained from the OB pixel value of forty-eight pixels on the first horizontal pixel line is 16 LSB level.

Therefore, in the effective pixel correction circuit 109, the level of the effective pixel value of the current line that is input in the effective pixel correction circuit 109 is uniformly increased by 32 LSB level, and the effective pixel value with the increased level is output as a corrected output value Dao.

At the same time, in the prediction arithmetic logic circuit 108, the average OB value Dav from the average circuit 107 is multiplied by ⅛ in the ⅛ circuit and the ⅛ average OB value Dav1 (2 LSB level) is output to the adding circuit 112. On the other hand, in the ⅞ circuit 111, the latch output from the latch circuit 113, or the initial value (48 LSB level), is multiplied by ⅞ and the ⅞ latch output Dpr7 (42 LSB level) is input in the adding circuit 112. In the adding circuit 112, the ⅛ average OB value Dav1 (2 LSB level) and the ⅞ latch output Dpr7 (42 LSB level) are added together, and the added value Dadd is output to the latch circuit 113.

(2) readout for pixel in the second pixel line

Next, when the pixel data of the second pixel line is read out by the A/D conversion circuit 103 to perform A/D conversion and then the A/D converted digital pixel value Dad is output to the transverse line correcting logic circuit 104, the digital pixel value Dad1 of the OB pixels in the left horizontal OB pixel section 101 is provided for the horizontal OB pixel average value generating circuit 110a similar to the digital value of the previous pixel horizontal line. After the digital pixel value Dad1 receives the limitation of the pixel value level in the upper limit limiting circuit 105 and the lower limit limiting circuit 106, the digital pixel value Dad1 is input in the average circuit 107.

However, when the pixel data of the second line is read out from the pixel section 110a to the A/D conversion circuit 103, the latch circuit 113 latches an added output of the adding circuit 112 at the rising timing of the enable signal B to the H level. Therefore, the latch output (Q1) is output as prediction OB values Dpr of the prediction arithmetic logic circuit 108 not only to the upper limit limiting circuit 105 and the lower limit limiting circuit 106 but also to the ⅞ circuit 111 in the prediction arithmetic logic circuit 108.

More specifically, the output (44 LSB level) obtained at the time of the previous readout for the pixel horizontal line from the adding circuit is input as a prediction OB value Dpr to the upper limit limiting circuit 105 and the lower limit limiting circuit 106. In the upper limit limiting circuit 105, 76 LSB level, in which a constant level width (32 LSB level) is added to the updated prediction OB value Dpr, is set to be a new upper limit value. On the other hand, in the lower limit limiting circuit 106, 12 LSB level, in which a constant level width (32 LSB level) is subtracted from the updated prediction OB value Dpr described above, is set to be a new lower limit value.

Subsequently, the OB pixel value of the second pixel line from the A/D conversion circuit is compared with the new upper limit value, or 76 LSB level, in the upper limit limiting circuit 105. Subsequent to the comparison, the horizontal OB pixel value of the input data is output without change to the lower limit limiting circuit 106 if the horizontal OB pixel value of the input data is smaller than the upper limit value, whereas the upper limit value is output as the horizontal OB pixel value to the lower limit limiting circuit 106 if the horizontal OB pixel value of the input data is larger than the upper limit value.

In the lower limit limiting circuit 106, the upper limit limiting pixel value Dur, which is an output from the upper limit limiting circuit 105, is compared with a new lower limit value, or 12 LSB level. As a result of the comparison, the lower limit value is output from the lower limit limiting circuit 106 if the upper limit limiting pixel value of the input data is smaller than the lower limit value, otherwise the upper limit limiting pixel value from the upper limit limiting circuit 105 is output without change to the average circuit 107 if the upper limit limiting pixel value of the input data is larger than the lower limit value.

As described above, when the digital pixel values Dad 1 of the OB pixels from the second line of the left horizontal OB pixel section is output to the average circuit 107 through the upper limit limiting circuit 105 and the lower limit limiting circuit 106, the average value (A2) of the digital values of forty-eight pixels out of sixty-four OB pixels in the second line of the left horizontal OB pixel section is extracted in the average circuit 107. The average value is output to the effective pixel correction circuit 109 and the prediction arithmetic logic circuit 108 as a corrected value (corrected horizontal BOB value) Dud of the average OB value Dav that is obtained from the pixel values of the OB pixels in the first pixel horizontal line.

In the effective pixel correction circuit 109, the digital pixel values Dad2 of the pixels in the effective pixel section, following the digital pixel values of the OB pixels in the left horizontal OB pixel section, are corrected based on the corrected horizontal OB value Duv from the average circuit 107.

Further, in the prediction arithmetic logic circuit 108, a new prediction OB value is generated based on the corrected horizontal OB value, which is the average value of the OB pixel values for one line in the left horizontal OB pixel section.

That is, it is assumed that A/D conversion is performed on the pixel data of the effective pixel section at the level lowered by 24 LSB level, in which 24 LSB level is subtracted from 48 LSB level that is a set value for the optical black, if, for example, the average OB value Dav that is obtained from the OB pixel values of 48 pixels in the second line (that is, the corrected horizontal OB values Dud that are corrected values of the horizontal OB values obtained for the first line) is 24 LSB level.

Therefore, the effective pixel correction circuit 109 outputs corrected values Dao, whose effective pixel data level of the current line (the second line) inputted in the effective pixel correction circuit 109 is uniformly increased by 24 LSB level, as effective pixel values.

At this time, in the prediction arithmetic logic circuit 108, the corrected horizontal OB values Dud from the average circuit 107 are multiplied by ⅛ in the ⅛ circuit and the ⅛ average OB value (3 LSB level) is input in the adding circuit 112. Further, in the ⅞ circuit 111, the latch output from the latch circuit 113, or the added value (44 LSB level) is multiplied by ⅞, and the ⅞ latch output (38.5 LSB level) is input in the adding circuit 112. In the adding circuit 112, the ⅛ average OB value (3 LSB level) and the ⅞ latch output (38.5 LSB level) are added together, and the added value (41.5 LSB level) is output to the latch circuit 113.

The latch circuit 113 latches the added value when pixels of the next line, which is the third line, are read out the latch circuit outputs the added value to the upper limit limiting circuit 105, the lower limit limiting circuit 106 and the ⅞ circuit 111 as a prediction OB value Dpr.

In this manner, by updating the average OB value based on the forty-eight pixels out of the OB pixel data of sixty-four pixels, which is in a previous line in the left horizontal OB pixel section 101 described above, the prediction OB value accumulated in the adding circuit 112 described above. In addition, after the prediction OB value is updated by the forty-eight pixels out of the pixel data of sixty-four pixels which is in a previous line in the left horizontal OB pixel section 101 described above, the enable signal to the latch circuit 113 is changed to the H level, so that the updated prediction OB value is taken in the latch circuit 113. The latest prediction OB value taken in the latch circuit 113 is used as a prediction value for forty-eight pixels out of the OB pixel data of sixty-four pixels of the next line in the left horizontal OB pixel section 101 described above.

In FIG. 5, A3 to An are corrected horizontal OB values Dud, which are output from the average circuit in reading out pixel values of lines on or after the third line, and Q2 to Qn are latch outputs, which are output from the latch circuit 113 as prediction OB values Dpr in reading out pixel values from the pixels of lines on or after the third line.

Because the readout for pixel data from each line are repeated, corrected horizontal OB values for one line that are output from the prediction arithmetic logic circuit 108 are consecutively updated and they are converged to a constant value, or the predefined optical black value. For example, in Embodiment 1, corrected horizontal OB values are updated when the pixel data of the first line through the eighth line are read out by the prediction arithmetic logic circuit 108. This is substantially because the corrected horizontal OB values are thought to be converged to a nearly predefined optical black value by updating the corrected horizontal OB values for eight pixel horizontal lines.

Thus, in Embodiment 1, the transverse line correcting logic circuit 104 is provided, the transverse line correcting logic circuit correcting the digital pixel values of the effective pixels in each horizontal pixel line based on the average horizontal optical black value, which is an average value for digital pixel values of a plurality of shaded pixels in a horizontal pixel line. The transverse line correcting logic circuit 104 clamps the digital pixel values of a plurality of shaded pixels in each of the horizontal pixel lines within a certain definite range and find the average of the clamped digital pixel values of the plurality of shaded pixels within a certain definite range so as to calculate the average horizontal optical black value, which is obtained by finding the average, for every horizontal pixel line. Therefore, the correcting logic circuit allows removing of noise such as white spot defect and correcting transverse lines by a simple process which clamps the digital pixel values of a plurality of shaded pixels within a certain definite range to find the average of the clamped OB pixel values of the plurality of shaded pixels within a certain definite range.

In addition, such a noise reduction for transverse lines as this is effective when the amplitude of the transverse line noise is in the same range or smaller than the amplitude of random noise, and the plurality of OB pixel values are limited within the range several times as large as the amplitude of the random noise.

Pixel values of pixels in the right horizontal OB pixel section may also be used for the calculation of the prediction OB value. Alternatively, pixel values of OB pixels in both the left horizontal OB pixel section and the right horizontal OB pixel section may be used. In addition, the calculation of the prediction OB values is not limited to the OB pixels from the top pixel line to the eighth pixel line, but OB pixels from more pixel lines may be used.

### Embodiment 2

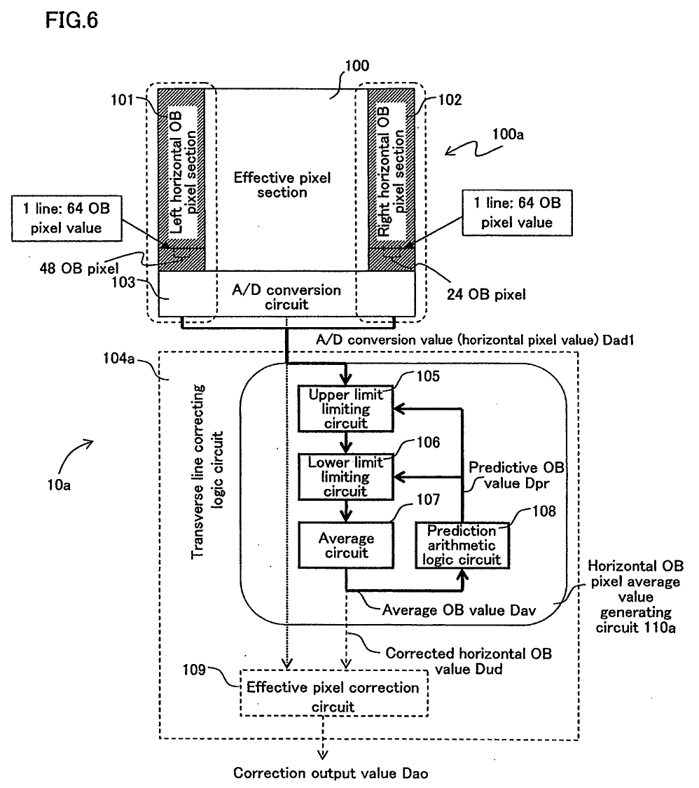

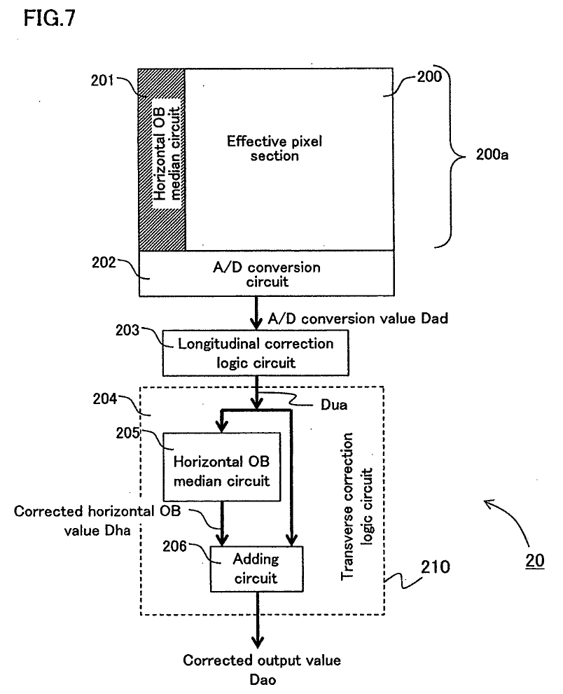

FIG. 6 is a diagram showing a solid-state image capturing apparatus according to Embodiment 2 of the present invention.

A solid-state image capturing apparatus 10a according to Embodiment 2 differs from the solid-state image capturing apparatus 10 according to Embodiment 1 in that the solid-state image capturing apparatus 10a performs the calculation for the prediction OB values using not only the pixel values from the left horizontal OB pixel section but also the pixel values from the right horizontal OB pixel section. The rest of the structure is the same as that of the solid-state image capturing apparatus 10 in Embodiment 1.

That is, similar to the solid-state image capturing apparatus 10 according to Embodiment 1, the solid-state image capturing apparatus 10a according to Embodiment 2 includes: a pixel section 100a having a plurality of pixels arranged in a matrix therein; an A/D conversion circuit 103 for performing A/D converting on pixel data (pixel signal) that are read out from the pixels to output digital pixel data Dad as an A/D conversion value; and a transverse line correcting logic circuit 104a for correcting the digital pixel value Dad outputted from the A/D conversion circuit 103 so as to suppress transverse line noise to output a transverse line corrected pixel value Dao as a corrected output value.

However, the transverse line correcting logic circuit 104a differs from the transverse line correcting logic circuit 104 in Embodiment 1 in that the horizontal OB pixel average value generating circuit 110a is provided with not only the pixel values of forty-eight OB pixels in the center of the left horizontal OB pixel section but also the pixel values of twenty-four OB pixels in the center of the right horizontal OB pixel section.

When the readout for pixel data for one frame starts, the pixel data (pixel signal) of the first horizontal pixel line are read out by the A/D conversion circuit 103 and A/D conversion is performed on the data. The A/D converted digital pixel data are output to the transverse line correcting logic circuit 104a as digital pixel values (A/D conversion values)

In Embodiment 2, twenty-four digital pixel values of the OB pixels in the right horizontal OB pixel section 102 followed by forty-eight digital pixel values Dad1 of the OB pixels in the left horizontal OB pixel section 101 are input in the horizontal OB pixel average value generating circuit 110a.

In this way, by using not only the pixel values of the OB pixels in the left horizontal OB pixel section but also the pixel values of the OB pixels in the right horizontal OB pixel section, it is allowed for the prediction OB value to be a value that is averaged even more, even in the case where substantial optical black values are different in the left side and the right side of the pixel section 100a, or where there is an inclination of the optical black values in the pixel section. As a result, noise such as white spot defect is removed, and at the same time, the transverse line noise is better suppressed.

Although Embodiments 1 and 2 include pixel sections that have both the left and right horizontal OB pixel sections, the pixel section may include only either of the left and right horizontal OB pixel sections.

Furthermore, although Embodiments 1 and 2 do not specifically describe whether the solid-state image capturing apparatuses of these embodiments are of a CMOS type or a CCD type, the present invention is intended for a CMOS image sensor, in which transverse line noise appears due to power source noise and the like, and the solid-state image capturing apparatus in the embodiment is a CMOS image sensor. However, it is also feasible to correct digital pixel values, which are A/D conversion values for pixel data, with the transverse line correcting circuit explained in Embodiment 1 or 2 described above in the case where transverse noise appears for some reasons in the CCD image sensor, so that the effect of the transverse line reduction can be obtained. Therefore, the solid-state image capturing apparatus according to the embodiments described above are also used as CCD image sensors.

Further, although not specifically explained in Embodiment 1 or 2 described above, an electronic information device will be described, the electronic information device including an image input device, such as a digital camera (e.g., digital video camera and digital still camera), an image input camera (e.g., a monitoring camera, a door intercom camera, a car-mounted camera, and a camera for television telephone, and a camera equipped in a cell phone), and an image input device (e.g., a scanner, a facsimile machine and a camera-equipped cell phone device) using at least either of the solid-state image capturing apparatuses 10 or 10a according to Embodiments 1 to 2 described above as an image capturing section.

### Embodiment 3

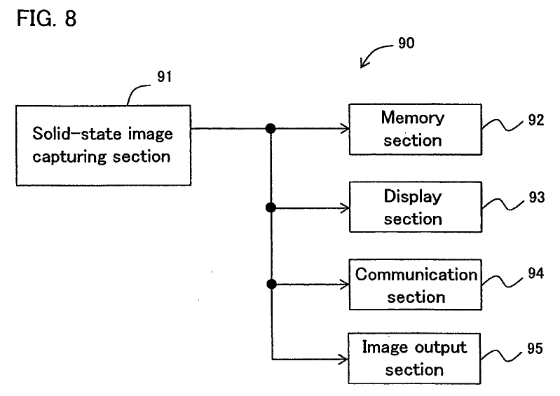

FIG. 8 is a block diagram showing an exemplary schematic structure of an electronic information device, the electronic information device using at least either of the solid-state image capturing apparatuses 10 or la according to Embodiments 1 to 2 of the present invention for an image capturing section thereof.

In FIG. 8, the electronic information device 90 according to Embodiment 3 of the present invention includes at least any of: an image capturing section 91 using at least either of the solid-state image capturing apparatuses 10 or 10a according to Embodiments 1 to 2; a memory section 92 (e.g., recording media) for data-recording a high-quality image data obtained by the image capturing section 91 after a predetermined signal process is performed on the image dada for recording; a display section 93 (e.g., liquid crystal display device) for displaying this image data on a display screen (e.g., liquid crystal display screen) after a predetermined signal process is performed for display; a communication section 94 (e.g., transmitting and receiving device) for communicating this image data after a predetermined signal process is performed on the image data for communication; and an image output section 95 for printing (typing out) and outputting (printing out) this image data.

As described above, the present invention is exemplified by the use of its preferred Embodiments 1 to 3. However, the present invention should not be interpreted solely based on Embodiments 1 to 3 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention provides a solid-state image capturing apparatus that is capable of performing a correction for a transverse line using a significantly simple logic circuit in the field of image sensors used for an electronic information apparatus, such as a video camera and a digital camera.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image capturing apparatus, comprising:
a pixel section having a plurality of pixels arranged in a matrix therein;
an A/D conversion circuit for performing A/D conversion of pixel signals that are read out from pixels of the pixel section to output digital pixel values; and
a correcting logic circuit for receiving the digital pixel values outputted from the A/D conversion circuit and correcting the digital pixel value of effective pixels on each of horizontal pixel lines based on an average horizontal optical black value, which is an average digital pixel value of a plurality of shaded pixels in a corresponding horizontal pixel line,
wherein the correcting logic circuit clamps the digital pixel values of a plurality of shaded pixels on each of the horizontal pixel lines within a certain definite range and find the average of the clamped digital pixel values of the plurality of shaded pixels within a certain definite range so as to calculate the average horizontal optical black value.

2. A solid-state image capturing apparatus according to claim 1, wherein the correcting logic circuit corrects a prediction optical black value for the next horizontal pixel line, the prediction optical black value being a center value for the certain definite range, so that the average horizontal optical black value for each of the horizontal pixel lines converges at a constant value.

3. A solid-state image capturing apparatus according to claim 1, wherein pixel signals of the shaded pixels are read out from the pixel section prior to pixel signals of the effective pixels, so that the digital pixel values of the shaded pixels on each of the horizontal pixel lines are input from the A/D conversion section to the correcting logic circuit prior to the digital pixel values of the effective pixels on the corresponding horizontal pixel lines.

4. A solid-state image capturing apparatus according to claim 3, wherein the pixel section includes a shaded region arranged only on one side in a horizontal pixel line direction.

5. A solid-state image capturing apparatus according to claim 4, wherein the average horizontal optical black value is generated from digital pixel values of part of shaded pixels arranged in the shaded region.

6. A solid-state image capturing apparatus according to claim 5, wherein the shaded pixels used for the generation of the average horizontal optical black value is located in the center portion of a horizontal pixel line direction in the shaded region.

7. A solid-state image capturing apparatus according to claim 3, wherein the pixel section is configured with a first shaded region arranged on one end side in a horizontal pixel line direction and a second shaded region arranged on the other end side in a horizontal pixel line direction.

8. A solid-state image capturing apparatus according to claim 7, wherein the average horizontal optical black value is generated from the digital pixel values of part of shaded pixels arranged in the first shaded region and the digital pixel values of part of shaded pixels arranged in the second shaded region.

9. A solid-state image capturing apparatus according to claim 8, wherein the shaded pixels used to generate the average horizontal optical black value are located in the center portion in a horizontal pixel line direction in the first and second shaded regions.

10. A solid-state image capturing apparatus according to claim 1, wherein the correcting logic circuit includes an effective pixel correction circuit for correcting digital pixel values of the effective pixels by adding a digital pixel value that corresponds to a difference between a set optical black value, which is set for the pixel section, and the average horizontal optical black value to the digital pixel values of the effective pixels.

11. A solid-state image capturing apparatus according to claim 10, wherein the correcting logic circuit includes an upper limit limiting circuit for limiting an upper limit value of digital pixel values of shaded pixels used to generate the average horizontal optical black value; and a lower limit limiting circuit for limiting a lower limit value of digital pixel values of shaded pixels used to generate the average horizontal optical black value.

12. A solid-state image capturing apparatus according to claim 10, wherein the correcting logic circuit includes an average circuit for averaging a plurality of digital pixel values that are clamped within a certain definite range to generate the average horizontal optical black value for every horizontal pixel line.

13. A solid-state image capturing apparatus according to claim 11, wherein the correcting logic circuit includes a prediction arithmetic logic circuit for calculating a predictive optical black value, which is used for a reference value to set the upper limit value of the upper limit limiting circuit and the lower limit value of the lower limit limiting circuit for the next horizontal pixel line, based on the average horizontal optical black value for each of the horizontal pixel lines so as to output the predictive optical black value to the upper limit limiting circuit and the lower limit limiting circuit.

14. A solid-state image capturing apparatus according to claim 13, wherein the prediction arithmetic logic circuit includes:
a first arithmetic circuit for multiplying the average horizontal optical black value by 1/n (n is a positive integer);
a second arithmetic circuit for multiplying the predictive optical black value by (n−1)/n;
an adding circuit for adding the outputs of the first and second arithmetic circuits; and
a latch circuit for latching an added output from the adding circuit to output the added output to the second arithmetic circuit as the predictive optical black value,
wherein the predictive optical black value is updated for each of the horizontal pixel lines.

15. A solid-state image capturing apparatus according to claim 14,
wherein the upper limit limiting circuit sets a pixel value that is higher than the predictive optical black value by a certain level as the upper limit value; and
wherein the lower limit limiting circuit sets a pixel value that is lower than the predictive optical black value by a certain level as the lower limit value.

16. A solid-state image capturing apparatus according to claim 15, wherein the correcting logic circuit limits the upper limit for the digital pixel values of the shaded pixels used for generating the average horizontal optical black value by the upper limit limiting circuit, and limits the lower limit for the digital pixel values of the shaded pixels used for generating the average horizontal optical black value by the lower limit limiting circuit, so that the correcting logic circuit clamps digital pixel values of a plurality of shaded pixels, which is used for generating the average horizontal optical black value, within a certain definite range with the predictive optical black value as a center.

17. A solid-state image capturing apparatus according to claim 1, wherein the solid-state image capturing apparatus is a CMOS image sensor.

18. A solid-state image capturing apparatus according to claim 1, wherein the solid-state image capturing apparatus is a CCD image sensor.

19. An electronic information device using the solid-state image capturing apparatus according to claim 1 as an image capturing section.
